(19) United States
(12) Patent Application Publication
(10) Pub. No.: US 2003/0150549 A1
(43) Pub. Date: Aug. 14, 2003

(54) Method for making a piece of simulated stained-glass

(76) Inventor: Donald Lutrario, Staten Island, NY (US)

Correspondence Address: Donald Lutrario, 1545 Woodrow Rd., Staten Island, NY, 10309, US

(21) Appl. No.: 10/072,535

(22) Filed: Feb. 8, 2002

(51) Int. Cl. B29C 51/10

(52) U.S. Cl. 156/245; 264/553

(57) ABSTRACT

A method for making a piece of simulated stained-glass that includes the steps of providing a vacuum mold die having a working surface, forming a series of completely flat and smooth, raised and elongated areas on the working surface of the vacuum mold die, laying a sheet of acrylic or plastic over the working surface of the vacuum mold die, vacuum forming the sheet of acrylic or plastic so as to form a sheet of vacuum formed acrylic or plastic having recessed flats on a mold-facing surface thereof and raised flats on an ambient-facing surface thereof that oppose the recessed flats, by virtue of the series of completely flat and smooth, raised and elongated areas on the working surface of the vacuum mold die, glueing pressure sensitive self-stick lead strips to the recessed flats on the mold-facing surface of the sheet of vacuum formed acrylic or plastic and the raised flats on the ambient-facing surface of the sheet of vacuum formed acrylic or plastic, and forming the piece of simulated stained-glass.

### BACKGROUND OF THE INVENTION

1. Field of the Invention

The present invention relates to a method. More particularly, the present invention relates to a method for making a piece of simulated stained-glass.

2. Description of the Prior Art

Numerous innovations for simulated stained-glass have been provided in the prior art that will be described. Even though these innovations may be suitable for the specific individual purposes to which they address, however, they differ from the present invention.

FOR EXAMPLE, U.S. Pat. No. 3,382,134 to Powell teaches a simulated Venetion glass product. A sheet transparent material is embossed onto a lead-simulating frame, with the sheet extending forwardly into the opening from the rear of the frame. Coloring material is deposited on the rear face of the sheet at each of the glass simulated areas. A highly authentic Venetian glass product is achieved by fabricating the transparent sheet with an irregular surface, and by attaching a translucent paper backing sheet to the assembly.

ANOTHER EXAMPLE, U.S. Pat. No. 3,619,456 to Taylor, Jr. teaches an assembly made from plastic which appears to be of stained glass set in lead, and the assembly can be made in any design that can be made by stained glass set in lead. The primary method for making the assembly is to arrange horizontally grooved plastic cames on a horizontal surface in the framework of the design desired, then to fill the design with a filler material to the bottom of the grooves, then to place variously colored liquid plastics in the design to fill it to the top of the grooves, next to cure the plastic, and finally to remove the filler material. In one variation of the method, no filler material is used and the liquid plastic fills the design from the bottom of the cames to the top of the grooves. When this variation is used, the resulting assembly appears to be stained glass set in lead only when viewed from one side.

STILL ANOTHER EXAMPLE, U.S. Pat. No. 4,016,235 to Ferro teaches a method of making simulated stained glass from moldable plastic material. One wall of a die is formed with a series of interconnected recesses which border isolated areas, and the isolated areas of the die are provided with random surface indentations. A sheet of plastic film having a series of dark colored interconnected strips, corresponding in configuration to the recesses in the die, and having a series of light colored zones of the same configuration as the isolated areas of the die, is disposed on the die surface with the dark colored strips in precise registry with the recesses of the die and the light colored zones in registry with the isolated areas of the die. The plastic film is held against the die surface by a vacuum, and a liquid thermoplastic resin is injected into the die cavity. The plastic film deforms under the heat and pressure to depress the dark colored strips of the film into the die recesses and the thermoplastic resin fuses to the plastic film to provide a simulated stained glass having raised dark colored strips corresponding to the leaded strips of stained glass, and having light colored areas corresponding to the panes of glass.

YET ANOTHER EXAMPLE, U.S. Pat. No. 4,312,688 to Brodis et al. teaches a method and apparatus for making simulated stained-glass uses an existing surface. An outline of a given design is traced or drawn on the surface to be decorated. Pressure-sensitive lead stripping is applied to the surface in registration with the outline thereby delineating lead-stripped areas. The edges of the lead stripping are boned, sealing same to the surface. Colored, plastic, thin-film stock is cut so as to be complementary in size to a given lead-delineated area, and then applied thereto. The lead stripping resembles a frame that appears to hold the thin-film stock, and it, in conjunction with the translucence of the thin-film, produces an effect that closely resembles real stained-glass.

STILL YET ANOTHER EXAMPLE, U.S. Pat. No. 4,335,170 to Butler teaches a method of simulating stained and leaded glass windows including bonding lead strips to a pane of glass or plastic to form design segments, and bonding coatings to the pane coincidental with the design segments to simulate colored glass and the simulated stained and leaded glass structure produced by the method.

YET STILL ANOTHER EXAMPLE, U.S. Pat. No. 4,438,165 to Butler that teaches simulated stained and leaded glass windows which include bonded lead strips onto a pane of glass or plastic, forming design segments, and bonded coatings to the pane coincidental with the design segments simulating colored glass, and to a method for their preparation.

STILL YET ANOTHER EXAMPLE, U.S. Pat. No. 6,117,504 to Yoshikawa teaches a stained glass article of a three dimensional shape and a method for producing the same. A glass plate is cut into glass pieces of a certain shape including a pentagon member and a hexagon member. The hexagon member consists of one six-sided irregular member and three four-sided irregular members. The glass pieces of the certain shape are united together via a bonding agent to obtain the three dimensional stained glass imitating the shape of a soccer ball. The glass piece has a curved surface whose radius of curvature is set substantially equal to the radius of the soccer ball.

It is apparent that numerous innovations for simulated stained-glass have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, it is an object of the present invention to provide a method for making a piece of simulated stained-glass that avoids the disadvantages of the prior art.

BRIEFLY STATED, it is an object of the present invention to provide a method for making a piece of simulated stained-glass that includes the steps of providing a vacuum mold die having a working surface, forming a series of completely flat and smooth, raised and elongated areas on the working surface of the vacuum mold die, laying a sheet of acrylic or plastic over the working surface of the vacuum mold die, vacuum forming the sheet of acrylic or plastic so as to form a sheet of vacuum formed acrylic or plastic having recessed flats on a mold-facing surface thereof and raised flats on an ambient-facing surface thereof that oppose the recessed flats, by virtue of the series of completely flat and smooth, raised and elongated areas on the working surface of the vacuum mold die, glueing pressure sensitive self-stick lead strips to the recessed flats on the mold-facing surface of the sheet of vacuum formed acrylic or plastic and the raised flats on the ambient-facing surface of the sheet of vacuum formed acrylic or plastic, and forming the piece of simulated stained-glass.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1D are a process flow chart for the method of making a piece of simulated stained-glass of the present invention.

List of Reference Numerals Utilized in the Drawing

10 method of present invention for making piece of simulated stained-glass 12

12 piece of simulated stained-glass

14 vacuum mold die

16 working surface of vacuum mold die 14

18 texture of piece of stained glass 20

20 piece of stained glass

22 water glass

24 granite glass

26 beveled diamonds

28 series of raised and elongated areas on working surface 16 of vacuum mold die 14

30 series of completely flat and smooth, raised and elongated areas on working surface

16 of vacuum mold die 14

32 acrylic jewels

34 glass

36 any other type item

38 sheet of acrylic or plastic

40 sheet of vacuum formed acrylic or plastic

42 recessed flats on mold-facing surface 44 of sheet of vacuum formed acrylic or plastic 40

44 mold-facing surface of sheet of vacuum formed acrylic or plastic 40

46 raised flats on ambient-facing surface 48 of sheet of vacuum formed acrylic or plastic 40

48 ambient-facing surface of sheet of vacuum formed acrylic or plastic 40

50 pressure sensitive self-stick lead strips

### DETAILED DESCRIPTION OF THE PREFERRED EMBODIMENT

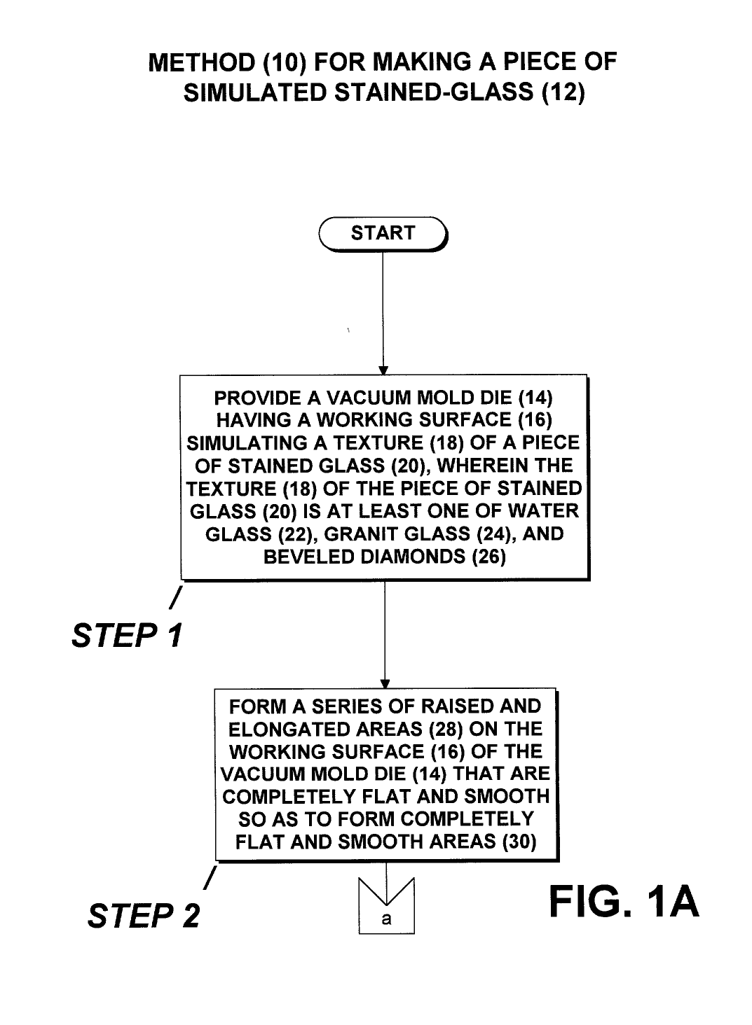

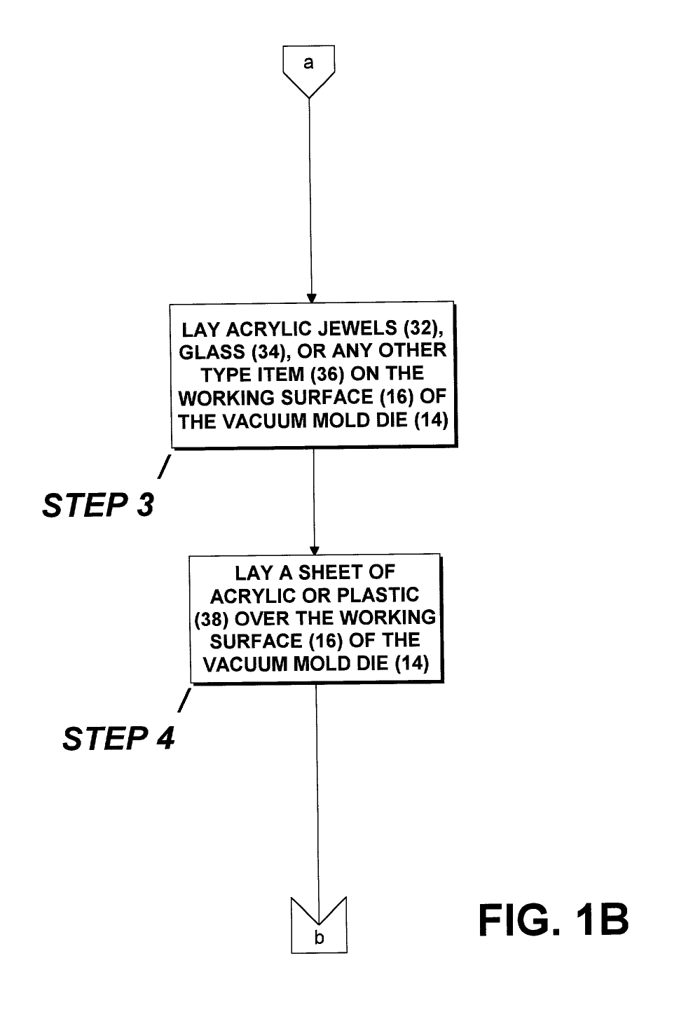

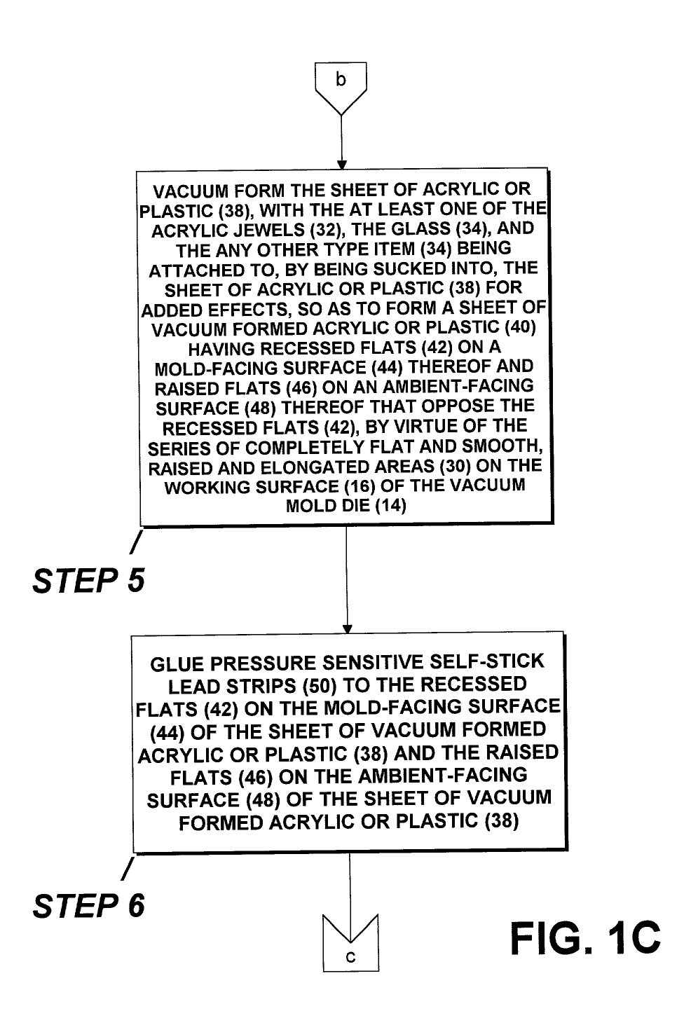

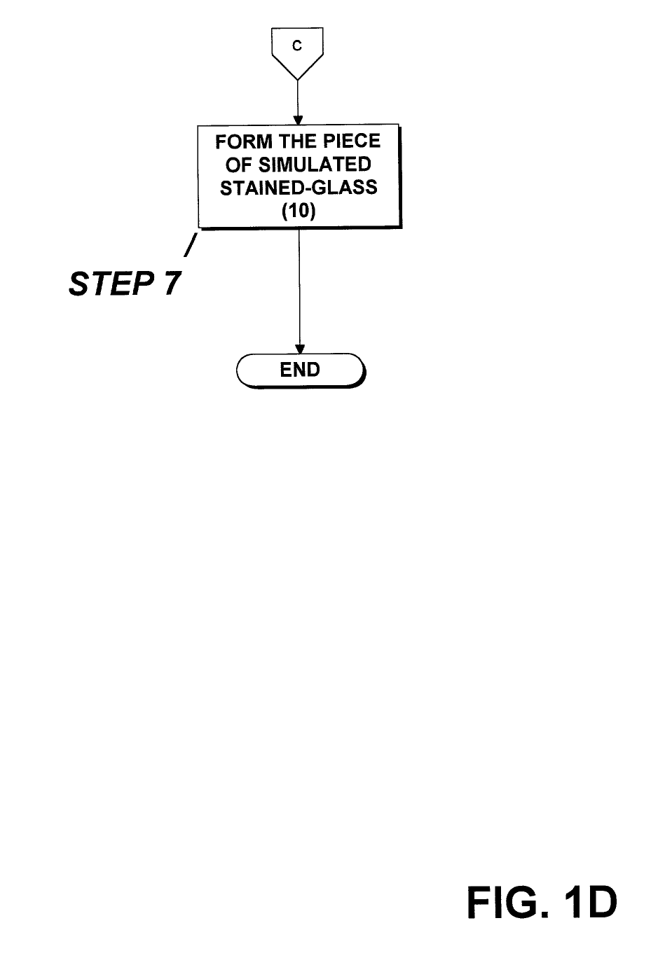

Referring now to FIGS. 1A-1D, which are a flow chart of the method for making a piece of simulated stained-glass of the present invention, the method of the present invention is shown generally at 10 for making a piece of simulated stained-glass 12.

The method 10 comprises the steps of:

STEP 1: Provide a vacuum mold die 14 having a working surface 16 simulating a texture 18 of a piece of stained glass 20, wherein the texture 18 of the piece of stained glass 20 is at least one of water glass 22, granite glass 24, and beveled diamonds 26.

STEP 2: Form a series of raised and elongated areas 28 on the working surface 16 of the vacuum mold die 14 that are completely flat and smooth so as to form a series of completely flat and smooth, raised and elongated areas on the working surface 16 of the vacuum mold die 14.

STEP 3: Lay at least one of acrylic jewels 32, glass 34, and any other type item 36 on the working surface 16 of the vacuum mold die 14.

STEP 4: Lay a sheet of acrylic or plastic 38 over the working surface 16 of the vacuum mold die 14.

STEP 5: Vacuum form the sheet of acrylic or plastic 38, with the at least one of the acrylic jewels 32, the glass 34, and the any other type item 34 being attached to, by being sucked into, the sheet of acrylic or plastic 38 for added effects, so as to form a sheet of vacuum formed acrylic or plastic 40 having recessed flats 42 on a mold-facing surface 44 thereof and raised flats 46 on an ambient-facing surface 48 thereof that oppose the recessed flats 42, by virtue of the series of completely flat and smooth, raised and elongated areas on the working surface 16 of the vacuum mold die 14.

STEP 6: Glue pressure sensitive self-stick lead strips 50 to the recessed flats 42 on the mold-facing surface 44 of the sheet of vacuum formed acrylic or plastic 38 and the raised flats 46 on the ambient-facing surface 48 of the sheet of vacuum formed acrylic or plastic 38.

STEP 7: Form the piece of simulated stained-glass 10.

It will be understood that each of the elements described above, or two or more together, may also find a useful application in other types of constructions differing from the types described above.

While the invention has been illustrated and described as embodied in a method for making a piece of simulated stained-glass, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claim is:

1. A method for making a piece of simulated stained-glass, comprising the steps of:
a) providing a vacuum mold die having a working surface;
b) forming a series of completely flat and smooth, raised and elongated areas on the working surface of the vacuum mold die;
c) laying a sheet of acrylic or plastic over the working surface of the vacuum mold die;
d) vacuum forming the sheet of acrylic or plastic so as to form a sheet of vacuum formed acrylic or plastic having recessed flats on a mold-facing surface thereof and raised flats on an ambient-facing surface thereof that oppose the recessed flats, by virtue of the series of completely flat and smooth, raised and elongated areas on the working surface of the vacuum mold die;
e) glueing pressure sensitive self-stick lead strips to the recessed flats on the mold-facing surface of the sheet of vacuum formed acrylic or plastic and the raised flats on the ambient-facing surface of the sheet of vacuum formed acrylic or plastic; and
f) forming the piece of simulated stained-glass.

2. The method as defined in claim 1, wherein said step of providing a vacuum mold die having a working surface includes providing a vacuum mold die having a working surface simulating a texture of a piece of stained glass.

3. The method as defined in claim 2, wherein said step of providing a vacuum mold die having a working surface simulating a texture of a piece of stained glass includes providing a vacuum mold die having a working surface simulating a texture of a piece of stained glass that is water glass.

4. The method as defined in claim 2, wherein said step of providing a vacuum mold die having a working surface simulating a texture of a piece of stained glass includes providing a vacuum mold die having a working surface simulating a texture of a piece of stained glass that is granite glass.

5. The method as defined in claim 2, wherein said step of providing a vacuum mold die having a working surface simulating a texture of a piece of stained glass includes providing a vacuum mold die having a working surface simulating a texture of a piece of stained glass that is beveled diamonds.

6. The method as defined in claim 1; further comprising the step of laying acrylic jewels on the working surface of the vacuum mold die; and
wherein said step of laying acrylic jewels on the working surface of the vacuum mold die occurs directly subsequently to said first forming step.

7. The method as defined in claim 1; further comprising the step of laying glass on the working surface of the vacuum mold die; and
wherein said step of laying glass on the working surface of the vacuum mold die occurs directly subsequently to said first forming step.

8. The method as defined in claim 1; further comprising the step of laying any other type item on the working surface of the vacuum mold die; and
wherein said step of laying any other type item on the working surface of the vacuum mold die occurs directly subsequently to said first forming step.

9. The method as defined in claim 6, wherein said step of vacuum forming the sheet of acrylic or plastic includes vacuum forming the sheet of acrylic or plastic with the acrylic jewels being attached to, by being sucked into, the sheet of acrylic or plastic for added effects.

10. The method as defined in claim 7, wherein said step of vacuum forming the sheet of acrylic or plastic includes vacuum forming the sheet of acrylic or plastic with the glass being attached to, by being sucked into, the sheet of acrylic or plastic for added effects.

11. The method as defined in claim 8, wherein said step of vacuum forming the sheet of acrylic or plastic includes vacuum forming the sheet of acrylic or plastic with the any other type item being attached to, by being sucked into, the sheet of acrylic or plastic for added effects.
